(19) United States
(12) Patent Application Publication
(10) Pub. No.: US 2016/0082843 A1
(43) Pub. Date: Mar. 24, 2016

(54) Method For Operating A Regenerative Braking Device Of A Motor Vehicle And Regenerative Braking Device For A Motor Vehicle

(71) Applicant: CONTINENTAL AUTOMOTIVE GMBH, Hannover (DE)

(72) Inventors: Akos Semsey, Regensburg (DE); Christoph Baumgaertner, Lappersdorf (DE); Martin Bruell, Barbing (DE); Egor Sawazki, Regensburg (DE)

(73) Assignee: Continental Automotive GmbH, Hannover (DE)

(21) Appl. No.: 14/779,813

(22) PCT Filed: Mar. 26, 2014
(86) PCT No.: PCT/EP2014/056031

§ 371 Date: Sep. 24, 2015

(30) Foreign Application Priority Data
Mar. 26, 2013 (DE) 10 2013 205 314.2

(51) Int. Cl. B60L 7/22; B60L 7/18

(52) U.S. Cl. CPC B60L 7/22; B60L 7/18

(57) ABSTRACT

A method for operating a regenerative braking device of a motor vehicle includes the steps of detecting a prespecified braking power value, and converting kinetic energy from the motor vehicle into electrical regenerative power in line with a setpoint braking power value which corresponds to the prespecified braking power value. The regenerative power is routed to an electrical storage device in order to charge the electrical storage device. The occurrence of a deviation between the setpoint braking power value and an actual braking power value, with which the motor vehicle is braked, is detected. The regenerative power is redirected from the storage device to a power resistor when, during routing of the regenerative power to the storage device, the occurrence of the deviation between the setpoint braking power value and the actual braking power value is detected.

### CROSS-REFERENCE TO RELATED APPLICATIONS

This application is a U.S. National Stage Application of International Application No. PCT/EP2014/056031 filed Mar. 26, 2014, which designates the United States of America, and claims priority to DE Application No. 10 2013 205 314.2 filed Mar. 26, 2013, the contents of which are hereby incorporated by reference in their entirety.

### TECHNICAL FIELD

The invention relates to the field of the regeneration of kinetic energy of motor vehicles and, in particular, to the controlled feeding of the regenerative energy to a battery in order to charge it, or to other consumers.

### BACKGROUND

It is generally known to recover kinetic energy of a motor vehicle by means of an electric machine. This is referred to as regeneration. The braking energy can be buffered as electrical energy and retrieved again. For the buffering of regenerative energy, in particular electrochemical or electrostatic accumulators are used.

Document DE 10 2011 016 227 discloses that in order to protect against overloading or thermal stressing of an electrical energy accumulator its charging power is reduced. In order to reduce the overall braking power it is proposed to activate the engine brake of an internal combustion engine in a metered fashion. In this context, the internal combustion engine is connected as required via a clutch.

On the one hand, over time this damages the internal combustion engine, and on the other hand a delay occurs in the activation of this additional brake, since in order to couple the engine brake electromechanical actuators are necessary to control a clutch, said actuators responding per se with a delay.

### SUMMARY

One embodiment provides a method for operating a regenerative braking device of a motor vehicle, comprising the steps: detecting a prespecified braking power value; converting kinetic energy of the motor vehicle into electrical regenerative power in accordance with a setpoint braking power value which corresponds to the prespecified braking power value, conducting the regenerative power to an electrical storage device in order to charge it, detecting if a deviation occurs between the setpoint braking power value and an actual braking power value with which the motor vehicle is braked; and diverting the regenerative power from the storage device to a power resistor if, during the conduction of the regenerative power to the storage device, it is detected that the deviation between the setpoint braking power value and the actual braking power value occurs.

In a further embodiment, after the diversion the regenerative power is partially or completely conducted to the power resistor and the setpoint braking power value is reduced compared to the prespecified braking power value over a prespecified time period.

In a further embodiment, after the diversion the regenerative power which is output to the power resistor is reduced to a minimum regenerative power over the prespecified time period.

In a further embodiment, conducting the regenerative power to the storage device comprises generating the regenerative power as a high voltage signal that charges a high-voltage battery device that forms the storage device.

In a further embodiment, the detection if a deviation occurs between the setpoint braking power value and the actual braking power value is provided by comparing the setpoint braking power value and the actual braking power value which corresponds to the regenerative power which is conducted to the electrical storage device or which is produced by the step of conversion of the kinetic energy; comparing the current deceleration with a deceleration which corresponds to the prespecified braking power value; and comparing a relative change over time of the prespecified braking power value with a relative change over time of the actual braking power value or a deceleration of the motor vehicle, or detecting a fault signal of the storage device or of an associated control device, wherein the fault signal indicates partial or complete decoupling of the storage device or represents partial or complete decoupling of the storage device.

In a further embodiment, after the diversion of the regenerative power from the storage device to the power resistor a friction brake is activated in order to at least partially compensate a difference between the setpoint braking power value or of the actual braking power value on the one hand, and the prespecified braking power value, on the other, by generating a braking power component.

Another embodiment provides a regenerative braking device for a motor vehicle comprising: an electric machine configured for connection to an output of the motor vehicle and for converting kinetic energy into regenerative power; an input interface configured for receiving a prespecified braking power value; a control device configured for determining a setpoint braking power value from the prespecified braking power value and for actuating the electric machine; and a power control device which is connected to the electric machine and is configured to apportion the regenerative power in a controllable fashion to a first output connection and a second output connection (162); characterized in that the power control device also has a detection device which is connected to the input interface and is configured to detect a deviation between the setpoint braking power value and an actual braking power value of the electric machine; and the power control device is configured, in the event of a deviation, to divert the regenerative power from the first output connection to the second output connection.

In a further embodiment, the power control device is connected in an actuating fashion to the control device of the electric machine and is configured to reduce the setpoint braking power value with which the control device actuates the electric machine, with respect to the prespecified braking power value at the input interface in accordance with a predefined reduction profile within the regenerative braking device, wherein the reduction profile preferably comprises a minimum regenerative power which represents the absolute minimum of the reduction profile.

In a further embodiment, the first and/or second output connection is configured as a high-voltage connection, in particular for a rated voltage of 200 V, 360 V, 400 V or more.

In a further embodiment, in order to detect the setpoint braking power value the detection device is connected to the control device, and in order to detect the actual braking power value it is connected to a power sensor of the electric machine, to a power sensor at the first output connection or to a control circuit of the control device; the detection device is connected to a speed input of the regenerative braking device which is configured for connection to a speed signal generator of the motor vehicle, or the detection device is connected to a fault signal input of the regenerative braking device which is configured for connection to monitoring electronics or to a control module of an electrical storage device, for the connection of which to the regenerative braking device the first output connection is configured.

In a further embodiment, the regenerative braking device also comprises a friction brake control output which is connected to the power control device, wherein the latter is configured to transmit a braking signal to the friction brake control output if a deviation detected by the detection device has occurred.

### BRIEF DESCRIPTION OF THE DRAWINGS

Example embodiments are discussed in detail below with reference to the drawings, in which:

FIG. 1 shows an example time profile of braking powers in order to explain in more detail the procedure described here; and

FIG. 2 shows an example embodiment of the regenerative braking device described here.

### DETAILED DESCRIPTION

The procedure described herein provides that in the event of a reduction or the loss of the electric batterie as power sink for the regenerative power, a mechanical or mechanically activated brake is not used for the compensation but instead a sink for electrical power is connected, which sink can, in particular, also absorb the full regenerative power in order to completely relieve the battery. The electrical regenerative power is, if necessary according to the procedure presented here, diverted partially or completely from an electrical storage device to a power resistor or some other electrical load. Since both power sinks between which diversion is carried out, i.e. the battery to be charged and the power resistor, take up the same type of energy, specifically electrical energy, the switchover process between these power sinks is essentially free of delay.

The equivalent power sink which is used here, specifically a power resistor or some other electrical load to which, if appropriate, the regenerative power is diverted, is essentially free of wear, and in contrast to the prior art no additional mechanical parts are used to divert or conduct the regenerative power. In addition, sudden shedding of the battery to be charged as a regenerative power sink can also be reacted to essentially free of delay and without preparation in advance, since the path of the regenerative power can be diverted through purely electronic switching means. It is therefore possible also to use the procedure described here in the event of a sudden disconnection of the battery, for example if a fault occurs or other protective mechanisms of the battery are triggered; coordination of the disconnection of the battery with other components can be eliminated. Even if the battery to be charged during a braking process as a regenerative power sink were to suddenly fail, the power resistor would essentially replace said battery without delay, in particular in respect of the level of the reduced regenerative power, with the result that despite the sudden failure of a component of the brake system (i.e. the battery to be charged) the braking behavior is not adversely affected by the change in the charging power of the battery. Since the regenerative power is present in electrical form and it can be diverted between electrical power sinks, there is also no suddenly occurring temporary failure of the braking power. This contributes to significantly improving traffic safety.

A method for operating a regenerative braking device of a motor vehicle is described. Firstly, a prespecified braking power value is detected. The prespecified braking power value corresponds to pedal activation of the brake pedal and/or of the accelerator pedal and can be detected, in particular, by detecting the position of the accelerator pedal or brake pedal or by detecting the force which is applied to the accelerator pedal or brake pedal. A small pedal activation, or none at all, of the accelerator pedal corresponds to a low prespecified braking power value which corresponds, in particular, to an engine braking effect which is known from vehicles with internal combustion engines. As the activation of the accelerator pedal decreases, the prespecified braking power value increases, wherein this preferably applies only to activations under a prespecified limit (correspondingly to very low activation). In contrast to the accelerator pedal, the prespecified braking power value increases with the activation of the brake pedal. The setting of a position of the pedal or the application of a force to the pedal is referred to as activation of the accelerator pedal or brake pedal. According to one way of considering the invention, with the activation of the accelerator pedal or brake pedal the driver sets the prespecified braking power value, a prespecified braking torque value or (indirectly) the degree of regeneration.

Using the position or the force which is applied to the accelerator pedal or brake pedal, a prespecified braking torque value is sensed directly on said accelerator pedal or brake pedal. Since said prespecified braking torque value corresponds directly to the prespecified braking power value via the rotational speed of the wheels of the motor vehicle, and the procedure described here considers power fluxes and the change therein, it is assumed here that with the prespecified braking torque value the prespecified braking power value is detected on the basis of the pedal activation. The prespecified braking torque value and the prespecified braking power value therefore equally represent a variable which represents the intensity of the brake activation with which the driver wishes to brake.

The prespecified braking power value is implemented by operating the regenerative braking device in accordance with the prespecified braking power value and, in particular, in accordance with a setpoint braking power value which corresponds (initially) to the prespecified braking power value. There is provision that kinetic energy of the motor vehicle is converted into electrical regenerative power. In particular, the kinetic energy is converted (at least at the start of the braking process) in accordance with the setpoint braking power value which corresponds to the prespecified braking power value. The kinetic energy of the motor vehicle is converted into electrical regenerative power in that the kinetic energy of the motor vehicle is retrieved from the motor vehicle. As a result, the motor vehicle is slowed or the acceleration (for example in the case of precipitous gradients) is reduced. The process of retrieving the kinetic energy takes place at a rate which is defined by the retrieved kinetic energy per unit of time. The rate is set by the prespecified braking power value and corresponds to the setpoint braking power value and preferably (at least at the start of the braking process) to the actual braking power value. The retrieved kinetic energy related to the unit of time in which this is retrieved can also be referred to as regenerative power. The conversion of the kinetic energy therefore comprises, in particular, the retrieving of the kinetic energy in accordance with the rate or in accordance with the prespecified braking power value or the setpoint braking power value and (at least temporarily) to the actual braking power value. The conversion comprises, in particular, also the conversion of the kinetic energy retrieved per unit of time (i.e. the retrieved kinetic power) into electrical power, which is referred to as regenerative power.

The setpoint braking power value represents the braking power with which the regenerative braking device is operated, and the prespecified braking power value corresponds to the prespecification which is input by the driver via the brake pedal. Since the setpoint braking power value and the prespecified braking power value correspond to one another, at least initially—at least at the start of the conversion step—the prespecified braking power is implemented as a setpoint braking power value by the regenerative braking device.

The prespecified braking power value can also be prespecified by a brake controller which is controlled in turn by a prespecification of the driver. The brake controller actuates both a friction brake and the regenerative braking device. The brake controller apportions the braking power requested by the prespecification of the driver, even without the occurrence of a deviation as is described below, into braking power with which the friction brake is operated and in a prespecified braking power value which is to be implemented by the regenerative braking device. Since the braking power which is prespecified by the driver is also output via the brake controller as a prespecified braking power value to the regenerative braking device, the braking power which is prespecified by the brake controller can also be considered to be a prespecified braking power value which is output by the driver.

The regenerative power is conducted to an electrical storage device in order to charge it. The converted kinetic energy can therefore be buffered in the storage device, in particular in order to retrieve said kinetic energy later, for example to provide traction to the motor vehicle. The regenerative power is preferably conducted to the electrical storage device during the conversion step.

In accordance with the procedure described here it is detected if a deviation occurs between the setpoint braking power value and an actual braking power value. In particular, it is detected if a negative deviation occurs, i.e. if the actual braking power value is lower than the setpoint braking power value. The actual braking power value corresponds to the braking power with which the motor vehicle is (actually) braked, i.e. the braking power with which the regenerative braking device and, if appropriate, further braking devices brake the motor vehicle. While the regenerative braking device uses the setpoint braking power value as a prespecification for operating the brake, the actual braking power value corresponds to the braking power which is actually applied by the regenerative braking device. A deviation corresponds to an error between the setpoint and actual values which is to be adjusted to zero in accordance with, for example, regulation within the regenerative braking device by corresponding actuation of the regenerative braking device. The actual braking power value and setpoint braking power value are therefore setpoint and actual values of a regulating process within the regenerative braking device. The deviation indicates if this regulating process cannot adjust the regulating error to zero. In particular, a deviation is detected which goes beyond a minimum deviation in order to avoid unnecessarily frequent diversion. The deviation is preferably the difference between the setpoint braking power value and the actual braking power value.

The regenerative power which is output as electrical power by the regenerative braking device is diverted from the storage device (as a first power sink for the regenerative power) to a power resistor (as a second, subsequent power sink for the regenerative power) if the deviation occurs, or as noted above, the deviation exceeds a preferably prescribed minimum deviation. The minimum deviation can correspond, for example, to 5, 10, 20 or 30% of the prespecified braking power value.

The diversion of the regenerative power means that the regenerative power no longer goes completely to the storage device but instead as a result of the diversion is conducted at least partially or completely to the power resistor if the diversion has taken place. The diversion is here the changing of the path (starting from the regenerative braking device) along which the regenerative power is conducted, or in other words the changing of the power sink (storage device or power resistor) for the regenerative power. In this case, the regenerative power can be diverted by partially or completely connecting the power resistor. In addition, the regenerative power can be diverted by at least partially removing a connection between the regenerative braking device and the storage device and partially or completely setting up a connection to the power resistor. The diversion can be provided by means of a two-pole switching device which connects the regenerative braking device to the power resistor in a controlled manner. In addition, the diversion can be provided by means of a three-pole switching device which optionally connects the regenerative braking device to the storage device or to the power resistor. Finally, the diversion can be provided by means of a first switching device which connects the regenerative braking device to the storage device, and a second switching device which connects the regenerative braking device to the power resistor. The first and second switching devices each have two poles. The switching states of the first and second switching devices can be complementary to one another, but are, in particular, different.

The switching device used is preferably a semiconductor switch, in particular a transistor such as an IGBT or MOSFET transistor. Alternatively, electromechanical switches can be provided, for example a relay or a contactor, which provide the respective switching device. The switching device can basically have two states, specifically conductive and non-conductive. In a deviation from this, further states can be provided in which the respective poles of the switching device are only partially connected to one another. For example, pulse-width-modulated actuation of the respective switching devices is considered to be partial connection, with the result that in respect of the time profile the corresponding poles are only partially connected to one another. The switching devices can comprise a series resistor as a protection against excessively high currents.

The diversion provides the path along which the regenerative power is conducted, is changed, and either a further power sink is connected or the regenerative power is discharged completely to another power sink. In this context, in particular the power resistor forms the further power sink. The term path along which the regenerative power is conducted is to be considered a connection within a topological consideration which comprises the regenerative braking device as a power source and the storage device and the power resistor as two power sinks.

One embodiment of the invention provides that after the diversion of the regenerative power (i.e. after the regenerative power is no longer conducted exclusively to the electrical storage device) the regenerative power is partially or completely conducted to the power resistor. The addition of the power resistor results in a further power sink which is in addition to or instead of the storage device. There is provision that the setpoint braking power value is reduced compared to the prespecified braking power value over a prespecified time period. In this context, the reduction is carried out in accordance with a prespecified time profile, for example in accordance with a constant reduction rate or in accordance with some other prespecified time profile. The prespecified time period prespecifies the time interval in which the power resistor has taken up the regenerative power. At the same time, the prespecified time period or the reduction or the reduction rate corresponds to a deviation, which can be compensated by the driver, of the setpoint braking power value from the prespecified braking power value. The time period is preferably less than a time period which would lead to overheating of the power resistor in the case of braking from a high speed (for example 100 km/h or 150 km/h). The time period can therefore depend on the thermal capacity of the power resistor, on a rated value of the setpoint braking power value or on the heat dissipation capacity of the power resistor if it dissipates heat. In addition, the time period therefore also depends on a rated operating temperature and on a maximum operating temperature. In this respect, the time period is, for example, below 2 minutes, 1 minute or 30 seconds. The maximum recall rate of the reduction is, for example, shorter than 50%, 20% or 10% of a rated value of the braking power of the regenerative braking device or of the prespecified braking power value with respect to 10, 20 or 30 seconds. This reduction rate permits, despite a reduction in the braking power, safe operator control of the vehicle such that the vehicle can adjust to the slow reduction. The power resistor is preferably configured thermally in such a way that, starting from a rated temperature (for example 20° C.), the temperature of said power resistor does not increase beyond a maximum temperature of the regenerative braking device during braking with a rated braking power of the regenerative braking device. This thermal configuration relates, in particular, to the thermal absorption capacity and/or to the thermal output power of the power resistor.

After the diversion, the setpoint braking power value in accordance with which the regenerative braking device is operated is preferably not reduced to zero but instead to a minimum regenerative power. There is provision that after the diversion the regenerative power which is output to the power resistor is reduced to the minimum regenerative power over the prespecified time period. Since the dynamics of the reduction, (i.e. which can be detected as a reduction rate or rate of change) are slower (or lower) than the dynamics (which can also be detected as a reduction rate) with which the driver can implement the reduction in a safe way during driving, the safety of driving is not adversely affected. In the case of a highly dynamic reduction in the setpoint braking power value, which reduction would occur if the regenerative power is not diverted as described here, in contrast an uncontrolled situation would arise for the driver.

In addition, at the end of the time period the driver likewise does not have to dispense with the function of the brake but rather in the preceding time period can accustom himself to the new driving behavior of the motor vehicle in order ultimately to brake the motor vehicle in accordance with the minimum regenerative power.

Furthermore there can be provision that a friction brake is connected within the time period or after the end of the time period. Since, as described above, the setpoint braking power value is reduced only at a low rate of change during the time period, there is sufficient time to actuate and connect the mechanical friction brake. The brake power of the friction brake is added to the braking power of the regenerative braking device, with the result that partial or complete failure of the storage device as a braking power sink can (immediately) compensate by diverting the regenerative power to the power resistor, and can be compensated over the long term by adding a friction brake. These compensation measures can be partial or complete. In the case of partial compensation, there is no comparatively rapid change or high rate of change of the setpoint braking power value, with the result that the rate of change is adapted to the reaction capability of the driver, and the driver can accustom himself in a safe way to new driving properties of the motor vehicle.

According to a further embodiment of the invention there is provision that during the conduction of the regenerative power to the storage device, the regenerative power is generated or passed on as a high voltage signal. The high voltage signal serves to charge a high voltage battery device which forms the storage device. The high voltage signal can have a voltage which is higher than 60 volts, in particular 100 volts, 150 volts, 230 volts, 380 volts, 400 volts, 600 volts or more. Furthermore, after the diversion, the high voltage signal can be output partially or completely to the power resistor. The latter is preferably embodied as a high voltage power resistor. Lines with a small cross section can be used for the use of a high voltage signal that conducts the regenerative power (to whatever energy sink), since given the same power smaller currents flow than in the case of signals with a relatively low voltage.

In accordance with further embodiments it is detected if a deviation occurs between the setpoint braking power value and the actual braking power value,
(i) in that regulating variables from the regulating process of the regenerative braking device are used;
(ii) in that the effect of the regenerative braking device on the motor vehicle is considered, in particular the slowing down thereof;
(iii) in that the time profile of the prespecified braking power value is compared with the time profile of the actual braking power value, or
(iv) in that a fault signal of the storage device or of an associated protection device or of a control device is detected in order to derive therefrom whether the storage device has been at least partially disconnected from the regenerative braking device owing to a fault or owing to some other event.

A first embodiment of this provides therefore that the deviation is detected by comparing the setpoint braking power value with the actual braking power value. This corresponds to the detection of a regulating error in the regulating process of the regenerative braking device. The actual braking power value corresponds here to the regenerative power which is diverted to the electrical storage device, or corresponds to the entire regenerative power which is produced as a result of the step of conversion of the kinetic energy (i.e. which is output by the regenerative braking device). This corresponds to the procedure mentioned above under (i).

Furthermore, there can be provision that the deviation is detected by comparing the current deceleration of the motor vehicle with a deceleration which corresponds to the prespecified braking power value. In this context, the actual braking of the motor vehicle is compared with the prespecified braking power value which is input by the driver of the motor vehicle by means of the brake pedal, for example. If differences are observed here it is to be assumed that the power sink for the regenerative power has decreased, for example if the current deceleration is lower than the prespecified braking power value, with the result that diversion occurs and the power resistor at least partially replaces the electrical storage device as the power sink for the regenerative power. This corresponds to the procedure mentioned above under (ii).

A further possibility is that a deviation is detected by comparing a relative change over time of the prespecified braking power value with a relative change over time of the actual braking power value, or a deceleration of the motor vehicle. In this context, the implementation of the prespecified braking power value is checked by the regenerative braking device, wherein the prespecified braking power value is compared with a regulating variable of the regenerative braking device, i.e. the actual braking power value (wherein instead of the actual braking power value it is also possible to use the setpoint braking power value). In addition, the relative change over time in the prespecified braking power value is compared with the relative change over time in the speed of the motor vehicle, with the result that errors in the implementation of the prespecified braking power value can also be detected here. This deviation leads to the assumption that the regenerative power cannot be output completely to the storage device, and that the power resistor is intended to be added (increasingly) as a power sink. This corresponds to the procedure mentioned above under (iii).

Finally, a further possibility is that a deviation is detected by detecting a fault signal. This can originate from the storage device, can originate from a control device or can originate from a protective device of the storage device. The fault signal can indicate partial or complete decoupling of the storage device. In this case, the storage device is not partially or completely decoupled until after the fault signal has lasted for more than a delay time period. For example, when a high temperature value of the storage device is detected which rises even further it is possible to assume that after a further time interval the storage device is at least partially decoupled, in order to counteract overheating. This can likewise apply to a high state of charge, wherein when a state of charge of 100% is approached, the storage device is partially or completely decoupled from the regenerative braking device in order to protect against overloading, wherein a high state of charge of, for example, 95, 98 or 99% indicates this switching off for the purpose of loading protection.

Alternatively, the fault signal can represent partial or complete decoupling of the storage device, with the result that the fault signal occurs essentially at the same time as the disconnection of the storage device. Instead of the fault signal it is also possible to use another event which influences the disconnection of the storage device or influences the triggering of a protective mechanism which protects the battery. This event may be, for example, the exceeding of a specific temperature value or the exceeding of a state of charge, wherein the battery enters a critical operating phase starting from the temperature value or starting from the state of charge. The use of a fault signal or detection of an event as described here corresponds to the procedure mentioned above under (iv).

According to a further embodiment of the invention, after the diversion of the regenerative power from the storage device to the power resistor a friction brake is activated. With the activation of the friction brake a difference between the prespecified braking power value, on the one hand, and of the setpoint braking power value or of the actual braking power value, on the other, is compensated. In particular, this difference is compensated by generating an (additional) braking power component which is added to the braking power of the regenerative braking device. In particular, the friction brake can be activated if a deviation between the setpoint braking power value and the actual braking power value exceeds a prespecified limit. In addition, the friction brake can be activated after a prespecified delay after the detection of the deviation, wherein the delay provides time for the actuation of the friction brake, and the latter therefore does not have to be connected suddenly.

The method described here is suitable, in particular, for road vehicles and off-road vehicles, preferably for passenger cars or trucks. The motor vehicle whose regenerative braking device is operated according to the method is equipped with a regeneration-capable drive which comprises the regenerative braking device. The regenerative braking device is provided, in particular, by an electric machine, which can also serve as a drive for the motor vehicle. The motor vehicle is equipped, in particular, with an electric drive or with a hybrid drive which has an electric driving mode and a combustion-engine-assisted driving mode.

Furthermore, a regenerative braking device for a motor vehicle is described, which regenerative braking device is suitable for carrying out the method specified above and uses, in particular, the variables specified above. The regenerative braking device comprises an electric machine configured for connecting to an output of the motor vehicle and for the conversion of kinetic energy of the motor vehicle into regenerative power. The connection between the electric machine and the output is a movement-transmitting connection.

In addition, the regenerative braking device comprises an input interface configured for receiving a prespecified braking power value. This input interface is provided, in particular by a brake pedal and an associated position sensor or force sensor.

Furthermore, the regenerative braking device comprises a control device which is configured for determining a setpoint braking power value from the prespecified braking power value. In addition, the control device is designed to actuate the electric machine. In this context, the control device can output control signals to the electric machine or comprise an output stage (or power electronics or a brake chopper) which is used to control currents which are generated by the electric machine (or which drive electric machine). The output stage, the power electronics or the brake chopper which is connected upstream of the electric machine is preferably configured for pulse-width-modulated actuation. The control device is assigned to the electric control device and connected upstream thereof, in order to actuate it.

The regenerative braking device also comprises a power control device. The latter is also connected to the electric machine. However, in contrast to the control device, the power control device is connected downstream of the electric machine and receives the regenerative power which is provided as electrical power and is generated by the electric machine during the regeneration or conversion. The power control device is configured to apportion the regenerative power (originating from the electric machine) in a controllable fashion to a first and a second output connection in a variable fashion and, in particular. The power control device can therefore be considered to be a switch for the regenerative power, which switch is generated by the electric machine.

In accordance with the procedure described here, the power control device has a detection device which is connected to the input interface. The detection device is configured to detect a deviation between the setpoint braking power value and an actual braking power value of the electric machine. The deviation can be detected, in particular, between the setpoint braking power value and the actual braking power value which is used in a regulating process of the electric machine, wherein the regulating process is preferably implemented by the control device. The power control device is configured, in the event of a deviation, to divert the regenerative power from the first output connection to the second output connection, either partially or completely. The detection device therefore controls the power control device which serves as a switch for the regenerative power. Generally, the power control device serves to apportion the regenerative power between the first and second output connections. The first output connection is provided for connection to an electrical storage device which is charged with the regenerative power, and the second connection is provided to be connected to a power resistor. The storage device comprises here electrostatic or preferably electrochemical energy storage cells and, in particular, charging electronics and/or protection electronics. In one specific embodiment, the regenerative braking device also comprises the charging electronics and/or the protection electronics.

The power control device is, as stated with respect to the method, implemented by means of a switching device which can be embodied, for example, as a semiconductor switch.

In accordance with one embodiment of the invention, the power control device is connected in an actuating fashion to the control device of the electric machine. The power control device is also configured to reduce the setpoint braking power value, with which the control device actuates the electric machine, compared to the prespecified braking power value which is present at the input interface, in accordance with a predefined reduction profile. The reduction profile is stored, for example, in a memory of the regenerative braking device, in particular as a value which specifies the reduction rate, or as a parameter quantity with which the profile is determined. The reduction profile preferably comprises a minimum regenerative power which represents the absolute minimum of the reduction profile. The minimum regenerative power corresponds, in particular, to the minimum regenerative power which is described above with reference to the method. The reduction profile is also preferably embodied as described above with reference to the method.

The minimum regenerative power is stored as a value in a memory, preferably in a (data) memory of the regenerative braking device and, in particular, within the same memory in which the reduction profile is also stored.

A further embodiment of the invention provides that the first and/or the second output connections are stored as high voltage connections. In particular, the first and/or the second output connections are configured for a rated voltage of 100 volts, 150 volts, 230 volts, 380 volts, 400 volts, 600 volts or more. This configuration can be implemented by means of corresponding insulating materials and insulating layers and the geometry thereof.

A further embodiment provides that, in order to detect the setpoint braking power value, the detection device is connected to the control device. In particular, the detection device is connected for this purpose to a control circuit of the control device which provides the regulating process, described here, of the regenerative braking device. In order to detect the actual braking power value, the detection device is connected to a power sensor of the electric machine, or to a power sensor at the first output connection or to a control circuit of the control device, in particular to the control circuit which is already mentioned.

The detection device is connected to a speed input of the regenerative braking device. The speed input is configured for connection to a speed signal generator of the motor vehicle. The speed signal generator can be, for example, a sensor which is connected to a wheel of the vehicle, or can be a navigation device which is configured for outputting the motor vehicle speed.

Alternatively, the detection device is connected to a fault signal input of the regenerative braking device. The fault signal input is configured for connection to monitoring electronics or to a control module of the electrical storage device, in particular to protection electronics or charging electronics as are described above. The regenerative braking device is configured for connecting the electrical storage device to the first output connection. The fault signal input can detect fault signals or else signals which represent events other than a fault, for example operating parameters of the storage device.

A further embodiment provides that the regenerative braking device also comprises a friction brake control output. The friction brake control output is connected to the power control device. The power control device is configured to transmit a braking signal to the friction brake control output if a deviation is detected, i.e. if a deviation which is detected by the detection device has occurred (or is imminent). As a result, the regenerative braking device can coordinate the delayed activation of the friction brake.

A further aspect is that a braking device is provided which comprises the regenerative braking device, as well as a friction brake which is activated by the friction brake control output or the signal thereof. In addition, a drive train can be provided which comprises the regenerative braking device and the storage device and/or the power resistor.

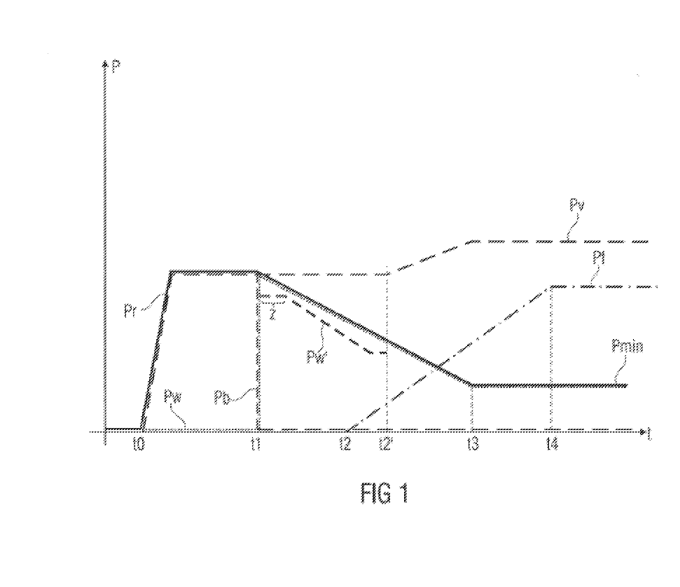

FIG. 1 shows curves which represent the profile of braking powers or regenerative powers as a function of the time t. The curve Pr which is indicated by an unbroken line illustrates the regenerative power which is converted by the electric machine. The curve Pv which is represented by a dashed line illustrates the prespecified braking power value. The curve Pb which is also illustrated with a dashed line illustrates the power which is connected to an electrical storage device. The curve Pw which is represented as dotted lines represents the power which is output to a power resistor. Finally, the dashed line Pf represents the braking power of the friction brake.

At the time t0, the driver starts a braking process, wherein the prespecified braking power value rises in accordance with the curve Pv starting from the time t0. A setpoint braking power value follows this rise, wherein the regenerative braking device is controlled in such a way that the actual braking power value also follows the prespecification. Up to the time t1, the prespecified braking power value corresponds to the setpoint braking power value which in turn corresponds to the actual braking power value. Up to the time t1, a regenerative power Pr, which corresponds to the setpoint braking power value, occurs. Up to the time t1, said generative power Pr is fed (completely) to the storage device.

At the time t1, an event occurs which causes the storage device to suddenly disconnect the regenerative braking device. Accordingly, the curve Pb which is illustrated by a dashed line, and which represents the power which is fed in to charge the storage device, decreases to zero. In accordance with the method according to the invention, the severe drop in the regenerative power which is conducted to the storage device for charging is detected, and the generated regenerative power, see curve Pr, is diverted essentially without delay to the power resistor and forms the power which is represented by the curve Pw.

At the time t1, the diversion occurs, wherein before the time t1 the regenerative power of the regenerative braking device is conducted completely to the storage device, cf. curve Pb, and after the diversion at the time t1, the regenerative power of the regenerative braking device is conducted completely to the power resistor, cf. curve Pw. Accordingly, with the time t1, or immediately afterwards, the braking power increases, said braking power being output by a power resistor and being represented by the curve Pw.

It can be seen from FIG. 1 that, starting from the time of the diversion, the prespecified braking power value, see curve Pv, remains constant, while the regenerative power which is generated (and therefore also the setpoint braking power value), see curve Pr, is reduced over a predefined time period. This time period extends from t1 to t3. In this context, after the time t1 the actual braking power value follows the setpoint braking power value, which in turn corresponds to the regenerative power which is represented by the curve Pr. The regenerative power, see curve Pr, is output completely to the power resistor after the time t1 and corresponds to the curve Pw. An increasing discrepancy between the prespecified braking power value, see curve Pv, and the setpoint braking power value is apparent and is represented by the regenerative power (at least up to the time t2), see curve Pr.

Starting from the time t2, which occurs after the time t1, a friction brake is additionally connected, as a result of which the additional braking power Pf is obtained. This is added to the braking power which results from the regenerative power (represented by curve Pr). The braking power of the friction brake (represented by curve Pf) therefore also compensates, from the time t2, the regenerative power which is absent from the time t1 and can be output to the storage device and which is represented by curve Pb. Furthermore, from the time t2 the braking power of the friction brake, represented by curve Pf, compensates the increasing discrepancy between the prespecified braking power value (curve Pv) and the braking power (curve Pr) which results from the regenerative power and which corresponds to the actual braking power value or setpoint braking power value.

From the time t3, the regenerative power is not decreased further, since at the time t3 the minimum regenerative power Pmin has been reached. It is apparent that from the time t4 the sum of Pmin and the braking power of the friction brake (dot-dash lines, curve Pf) corresponds to the prespecified braking power value (curve Pv).

It is apparent that from a time t2′, which occurs just after the time t2, the prespecified braking power value (curve Pv) rises slightly, since the driver corrects the increasing discrepancy between the prespecified braking power value (curve Pv) and the actual braking power value by increasingly activating the brake pedal. Starting from the time t3 (or later), such an increasing activation of the brake pedal is, however, no longer necessary, since from this time the discrepancy between the prespecified braking power value and the sum of the braking power of the friction brake, see curve Pf, and the braking power which results from regeneration, see curve Pr, is reduced.

In addition it is to be noted that from the time t2 the discrepancy between the prespecified braking power value, curve Pv, and the total braking power does not grow any further since from the time t2 the braking power of the friction brake, curve Pf, increases and compensates the decreasing braking power which results from the regenerative power, curve Pr. In FIG. 1, the curve Pf rises in the same way as the curve Pr decreases. However, the absolute value of the gradients can also differ from one another.

The curve Pw′ shows an alternative profile of the regenerative power from the time t1, wherein at the time t1 or following it the setpoint braking power value is reduced suddenly compared to the prespecified braking power value. After the sudden reduction, the braking power is kept constant for a time period z. A monotonous reduction follows. As a result of the jump at the time t1, the driver is informed that the braking power will be subsequently reduced. After the jump, the difference between the setpoint braking power value and the prespecified braking power value is kept constant for a time period which is sufficient to give the driver time to accustom himself to the subsequently changing braking behaviors. The time period z in which the difference between the setpoint braking power value and the prespecified braking power value is kept essentially constant is preferably at least 1 second, 2 seconds, 5 seconds or 10 seconds.

In addition it is possible to provide that after the time t1 the profile of the difference between the prespecified braking power value and the actual braking power value or else the reduction profile of the difference does not have a bend and, in particular, the second time derivative of the difference starting from the time t1 remains finite or remains below a predefined value. This also preferably applies to the first time derivative of the reduction. The difference is a monotonously falling function at the time t1, and the reduction is represented by such a function and can, in particular, be strictly monotonously falling in certain sections, at least up to the time t1.

It is apparent that firstly the setpoint braking power value is reduced by a reduction rate or to a value (or values) which permits/permit safe driving of the motor vehicle. This reduction rate or this value is adapted to a regulating behavior which is typical of a person, wherein, for this purpose, in particular regulating models, are used as the basis, said models modeling the regulating behavior of a person. Afterwards, the setpoint braking power value is reduced to a value (or values) which reflects/reflect the limited thermal absorption capacity of the regenerative resistor. This can be defined by a maximum operating temperature of the resistor, thermal transfer properties, the thermal capacity or by other properties of the regenerative resistor.

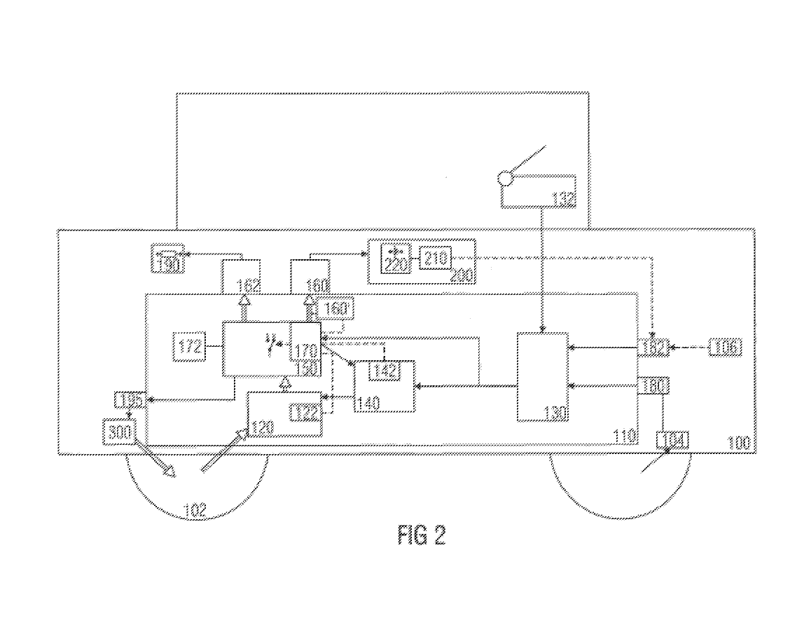

FIG. 2 shows, as a schematic illustration, a motor vehicle with a regenerative braking device according to the invention in order to explain in more detail the method described here. The illustrations are symbolic and, in particular do not define a spatial reference of the illustrated components with respect to one another.

The motor vehicle 100 comprises a regenerative braking device 110 with an electric machine 120. The electric machine is mechanically connected to an output 102 of the motor vehicle 100, as is shown by the double arrow 120 which is directed to the electric machine.

The double arrow 120 represents the transmission direction of kinetic energy. The regenerative braking device 110 also comprises an input interface 130 for receiving a prespecified braking power value which can originate, for example, from a symbolically illustrated brake pedal 132 or from the position signal generator thereof.

In addition, a control device 140 for actuating the electric machine 120 is provided. The control device 140 is configured for determining a setpoint braking power value. The regenerative braking device 110 also comprises a power control device 150 which is connected to a first output connection 160 and a second output connection 162, in order to apportion in a controlled fashion the electrical power which is output by the electric machine 120. The vertical double arrows show here the controllable division or the apportioned power flux.

The power control device 150 also comprises a detection device 170 which detects a deviation between the setpoint braking power value and an actual braking power value of the electric machine 120. As is illustrated symbolically, the detection device 170 actuates the apportioning function of the power control device 150. The power control device 150 diverts the regenerative power, which is output as electrical power by the electric machine 120, between the first and second output connections 160, 162 in a controlled fashion.

The output connection 160 is connected to an electrical storage device 200, which output connection 160 is, in particular, not part of the regenerative braking device 110 and comprises transmission electronics 210 (or else a control module, not illustrated) as well as chargeable cells 220 which embody the energy accumulator of the storage device.

The regenerative braking device 110 also comprises a reduction profile 172 which can be provided as values which are stored in a data memory. The reduction profile represents a chronologically increasing (preferably negative) deviation between the prespecified braking power value, on the one hand, and the setpoint braking power value as well as the actual braking power value, on the other, as is illustrated in FIG. 1. The reduction profile 172 preferably also comprises a minimum regenerative power, in particular as a value which is stored in the memory and in which the values which represent the reduction profile of the regenerative power compared to the prespecified braking power value are also stored.

The detection device 170 can determine the deviation in various ways, FIG. 2 illustrating a number of possibilities in this context. Here, as illustrated in FIG. 2, the detection device 170 can be connected to the control device 140, in particular to a control circuit of the control device 140, in order to detect a discrepancy between the setpoint value and actual value with respect to the braking power. In the case of a discrepancy which is above a predefined limit, the regenerative power is partially or completely diverted by means of the device 150, to the second output connection or to the power resistor.

In addition, the detection device 170 can be connected to a power sensor 122 of the electric machine or to a power sensor 160′ at the first output connection 160. The power sensor can be embodied, in particular, as a current sensor, for example as a Hall sensor or as a shunt sensor. In this context, the detection device 170 detects a deviation between the setpoint value and actual value with respect to the braking power of the electric machine 120 on the basis of regulating variables or output variables of the electric machine.

As an alternative, the detection device 170 can be connected to a speed input 180 of the regenerative braking device 110. FIG. 2 illustrates that this connection runs via the input interface 130, but this can also be bypassed and a direct connection can be present between the speed input and the detection device 170. The speed input is connected to a speed signal generator 104 of the motor vehicle 100. FIG. 2 illustrates a speed signal generator 104 which detects the wheel movement and determines the speed of the motor vehicle 100 therefrom. However, the speed signal generator 104 can also alternatively be a navigation device which outputs a speed signal in a known fashion. On the basis of the speed of the vehicle, the detection device 170 can determine if the braking of the vehicle 100 deviates from the prespecified braking power value of the brake pedal 132. The regenerative braking device can react to this deviation and, for example, increase the braking power by virtue of the fact that the power control device 150 diverts the braking power to the first output connection 160. It is assumed here that in the case of a deviation of the actual braking of the vehicle 110 from the prespecified braking power value of the brake pedal 132 the regenerative power of the electric machine 120 is no longer completely taken up by the storage device 200 and therefore at least part of the regenerative power is also output to the second output connection 162 which is connected to a regenerative resistor or power resistor 190.

Furthermore, it is possible for the detection device 170 to be connected to a fault signal input 182 of the regenerative braking device. The fault signal input 182 is connected to the monitoring electronics or to a control module of the storage device 200, as is illustrated by the arrow, represented by dashed lines, between these components. The monitoring electronics 210 disconnect the electrical storage device 200 from the first output connection 160, at least partially, and the control module (this can be represented by the symbolic elements of the reference symbol 210), controls the charging process of the storage device 200. When a fault occurs, for example when there is an excessively high temperature or an excessively high current, the monitoring electronics 210 disconnect the energy accumulator here, and the control module reduces the charging power, with the result that the regenerative power can no longer be taken up fully by the storage device 200. If monitoring functions or control functions of the storage device 200 or of other drive components which influence the regenerative power are implemented by a central controller 106, the fault signal input 182 can also be configured to connect the latter. The fault signal input can also be referred to as an event signal input, in particular if the latter is configured to receive event signals which define the current or future regenerative operation of the regenerative braking device 110. The central controller 106 can be implemented as a central control device.

The regenerative braking device 100 can also comprise a friction brake control output 195 which actuates a friction brake 300 which acts on the output 102 of the motor vehicle 100. In this context, the power controller device 150 can transmit a brake signal or else a preparation signal to the friction brake control output 195 in order to activate the friction brake after the diversion of the regenerative power by the power control device 150 or can prepare it for activation. Activation is understood here to mean, in particular, the activation of the friction brake 300 or the preparation for activation.

FIG. 2 illustrates that the fault signal input 182 is connected to the detection device 170 via the input interface 130. However, this can also be a direct connection between the fault signal input 182 and the detection device 170.

In addition, the detection device 170 may not be provided within the power control device 150 but instead within a device of the regenerative braking device, but outside the power control device. For example, the controller 140 and the detection device 170 can be combined as a device which actuates the electric machine 120 and the power control device 150. In addition, the detection device 170 can be combined with the input interface 130. The function of the detection device or of the control device can be implemented as software which runs on a processor. This processor can also comprise the interface 130.

The power control device 150 is preferably configured as an IGBT or MOSFET switch or else, if appropriate, as an electromechanical relay, and in one particularly simple exemplary embodiment it can be a simple switch which can be switched on and off and can connect the second output connection 162, with the result that at least part of the regenerative power can also pass from the electric machine 120 to the power resistor 190. The power control device 150 is preferably configured to apportion the regenerative power, respectively partially or completely, to one of the connections 160, 162 in a pulse-width modulated fashion and is for this purpose preferably configured as a semiconductor switch.

The power resistor 190 can be thermally connected to a heat sink, in particular to a cooling circuit of the motor vehicle or to a heat sink body. The power resistor 190 can be gas-cooled or liquid-cooled and, in particular, air cooled or water cooled.

### LIST OF REFERENCE SYMBOLS

Pr Curve, which represents the regenerative power of the electric machine 120
Pw Curve which represents the regenerative power conducted to the power resistor
Pb Curve which represents the regenerative power conducted to the storage device
Pv Curve which represents the prespecified braking power value
Pf Curve which represents the braking power of the friction brake Pmin Minimum regenerative power
t0-t4 Times
Z Time period
100 Motor vehicle
102-106: Components of the motor vehicle 100: output 102, speed signal generator 104 and central controller 106
110 Friction brake
120 Electric machine
122 Power sensor of the electric machine
130 Input interface
140 Control device
142 Control circuit of the control device
150 Power control device
160, 162 First and second output connections (power connection)
160′ Power sensor at the first output connection
170 Detection device
180 Speed input
182 Fault signal input
190 Power resistor
195 Friction brake control output
200 Electrical storage device of the vehicle
210 Monitoring electronics of the storage device
220 Storage cells of the storage device 200
300 Friction brake of the vehicle

What is claimed is:

1. A method for operating a regenerative braking device of a motor vehicle, comprising:
detecting a prespecified braking power value;
converting kinetic energy of the motor vehicle into electrical regenerative power based on a setpoint braking power value that corresponds to the prespecified braking power value,
conducting the regenerative power to an electrical storage device to charge the electrical storage device:
while conducting the regenerative power to the electrical storage device, detecting a deviation between the setpoint braking power value and an actual braking power value that brakes the motor vehicle; and
in response to detecting the deviation between the setpoint braking power value and the actual braking power value, diverting the regenerative power from the storage device to a power resistor.

2. The method of claim 1, comprising, after diverting the regenerative power, conducting at least a portion of the regenerative power to the power resistor and reducing the setpoint braking power value compared to the prespecified braking power value over a prespecified time period.

3. The method of claim 2, comprising, after diverting the regenerative power, reducing the regenerative power that is output to the power resistor to a minimum regenerative power over the prespecified time period.

4. The method of claim 1, wherein the storage device comprises a high-voltage battery device, and wherein conducting the regenerative power to the storage device comprises generating the regenerative power as a high voltage signal that charges the high-voltage battery device.

5. The method of claim 1, wherein detection a deviation between the setpoint braking power value and the actual braking power value comprises:
comparing the setpoint braking power value and the actual braking power value that corresponds to the regenerative power which is conducted to the electrical storage device or which is produced by the conversion of the kinetic energy; or
comparing the current deceleration with a deceleration that corresponds to the prespecified braking power value; or
comparing a relative change over time of the prespecified braking power value with a relative change over time of the actual braking power value or a deceleration of the motor vehicle; or
detecting a fault signal of the storage devices or of an associated control device, wherein the fault signal indicates partial or complete decoupling of the storage device or represents a partial or complete decoupling of the storage device.

6. The method of claim 1, comprising, after diverting the regenerative power from the storage device to the power resistor, activating a friction brake to at least partially compensate a difference between (a) the setpoint braking power value or of the actual braking power value and (b) the prespecified braking power value by generating a braking power component.

7. A regenerative braking device for a motor vehicle, comprising:
an electric machine configured for connection to an output of the motor vehicle and for converting kinetic energy into regenerative power;
an input interface configured to receive a prespecified braking power value;
a control device configured to determine a setpoint braking power value from the prespecified braking power value and for actuating the electric machine; and
a power control device connected to the electric machine and configured to apportion the regenerative power in a controllable fashion to a first output connection and a second output connection,
wherein the power control device comprises a detection device connected to the input interfaced and configured to detect a deviation between the setpoint braking power value and an actual braking power value of the electric machine; and
wherein the power control device is configured to divert the regenerative power from the first output connection to the second output connection in response to a deviation.

8. The regenerative braking device of claim 7, wherein the power control device is connected in an actuating manner to the control device of the electric machine and is configured to reduce the setpoint braking power value with which the control device actuates the electric machine, with respect to the prespecified braking power value at the input interface in accordance with a predefined reduction profile within the regenerative braking device,
wherein the reduction profile comprises a minimum regenerative power that represents an absolute minimum of the reduction profile.

9. The regenerative braking device of claim 7, wherein at least one of the first or second output connection is configured as a high-voltage connection for a rated voltage of at least 200 V.

10. The regenerative braking device of claim 7, wherein:
the detection device is connected to the control device for detecting the setpoint braking power value, and
the detection device is connected to a power sensor of the electric machine, to a power sensor at the first output connection, or to a control circuit of the control device for detecting the actual braking power value;
the detection device is connected to a speed input of the regenerative braking device which is configured for connection to a speed signal generator of the motor vehicle, or the detection device is connected to a fault signal input of the regenerative braking device which is configured for connection to monitoring electronics or to a control module of an electrical storage device.

11. The regenerative braking device of claim 7, comprising a friction brake control output connected to the power control device, wherein the power control device is configured to transmit a braking signal to the friction brake control output in response to a detection of a deviation by the detection device.
